(19) United States
(12) Patent Application Publication
(10) Pub. No.: US 2023/0019845 A1
(43) Pub. Date: Jan. 19, 2023

(54) Bowling-ball Cleaning Pad

(71) Applicant: Timothy Schmidt, Saint Cloud, MN (US)

(72) Inventor: Timothy Schmidt, Saint Cloud, MN (US)

(21) Appl. No.: 17/864,195

(22) Filed: Jul. 13, 2022

Related U.S. Application Data
(60) Provisional application No. 63/221,408, filed on Jul. 13, 2021.

(51) Int. Cl. A63B 47/04

(52) U.S. Cl. CPC A63B 47/04; A63B 2243/0054

(57) ABSTRACT

A bowling-ball cleaning pad that removes residue from a bowling ball includes a first debris-collecting layer, a second debris-collecting layer, and at least one liquid-absorbing layer. The at least one liquid-absorbing layer is sandwiched in between the first debris-collecting layer and the second debris-collecting layer. The first debris-collecting layer, the second debris-collecting layer, and the at least one liquid-absorbing layer are coextensive with each other. The first debris-collecting layer and the second debris-collecting layer are perimetrically connected to each other. Depending upon different embodiment of the bowling-ball cleaning pad, the at least one liquid-absorbing layer can absorb only oil, only water, or water and oil.

The current application claims a priority to the U.S. Provisional Patent application Ser. No. 63/221,408 filed on Jul. 13, 2021.

### FIELD OF THE INVENTION

The present invention relates to absorption towels and pads. More specifically, the present invention is a pad that is utilized to clean and absorb residue from a surface of a bowling ball.

### BACKGROUND OF THE INVENTION

Bowling is a well-known activity that can be picked up by anyone as a hobby or a fun social activity with a group of people. In addition, bowling is not only a fun activity, but it is also a competitive sport. Whether it is a social activity with a group of friends or a competition between people, it is important to have a clean bowling ball readily available for rolling down the bowling lane. It is known that residue such as oil, sweat, dirt, etc. may have effects of interrupting the bowling ball's pathway from the players hand to the bowling pins. Thus, in competitive bowling there are many players that always uses a microfiber towel or of the likes to wipe and clean the bowling ball right before every shot to the bowling pins. However, not all existing microfiber towels or of the likes can sufficiently remove residue such as oil and sweat off of the surface of a bowling ball.

An objective of the present invention is to provide a uniquely designed cleaning pad for the removal of residue from a bowling ball. The present invention provides a cloth pad that comprises an oil absorbent and/or water absorbent pad within the interior to keep the exterior of the present invention dry for continuous and multiple use. As a result, the present invention is a cleaning pad that removes residue such as oil from a bowling ball to provide the user a more accurate shot and improves the longevity of the user's equipment. Furthermore, the present invention can be utilized to clean and polish not only a bowling ball but any desired surface such as a window, countertop, cabinets, furniture, etc.

### BRIEF DESCRIPTION OF THE DRAWINGS

FIG. 1 is a side view of the present invention showing the first debris-collecting layer.

FIG. 2 is a side view of the present invention showing the second debris-collecting layer.

FIG. 3 is a cross-sectional view of the present invention showing the first debris-collecting layer, the second debris-collecting layer, and the liquid-absorbing layer.

FIG. 4 is a schematic view showing the first debris-collecting layer, the second debris-collecting layer, and the liquid-absorbing layer.

FIG. 5 is a schematic view showing the printed graphic of the present invention.

### DETAIL DESCRIPTIONS OF THE INVENTION

All illustrations of the drawings are for the purpose of describing selected versions of the present invention and are not intended to limit the scope of the present invention.

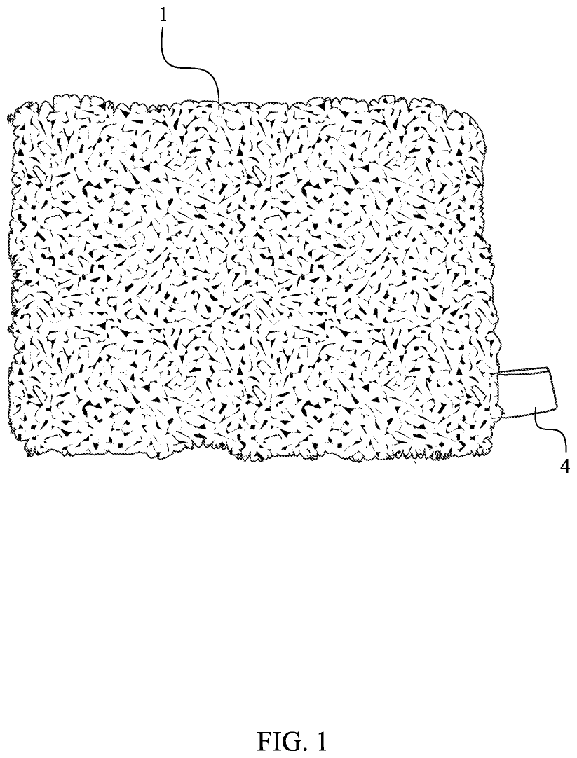

The present invention is a bowling-ball cleaning pad that is uniquely designed pad designed to remove residue such as oil, dust, water, dirt, etc. off of a bowling ball. The present invention has a highly absorbent and wicking interior to draw excess oil and/or water out of the exterior material of the bowling-ball cleaning pad to keep the exterior material dry and ready for continuous and multiple use. Furthermore, the present invention can be utilized to clean and polish not only a bowling ball but any desired surface such as a window, countertop, cabinets, furniture, and other similar objects. As shown in FIGS. 1-3, the present invention comprises a first debris-collecting layer 1, a second debris-collecting layer 2, and at least one liquid-absorbing layer 3.

In reference to the general configuration of the present invention, as shown in FIGS. 1-4, the at least one liquid-absorbing layer 3 is sandwiched in between the first debris-collecting layer 1 and the second debris-collecting layer 2 as the at least one liquid-absorbing layer 3 is fully enclosed by the first debris-collecting layer 1 and the second debris-collecting layer 2. The first debris-collecting layer 1, the second debris-collecting layer 2, and the at least one liquid-absorbing layer 3 being coextensive with each other thus defining the general shape of the present invention. Preferably, the present invention is shaped into a rectangular shape to ease storage purposes and to ease usage. The first debris-collecting layer 1 and the second debris-collecting layer 2 are perimetrically connected to each other so that the at least one liquid-absorbing layer 3 can be fully protected within.

In reference to FIGS. 1-4, the first debris-collecting layer 1 is a soft cloth-like surface that is used to wipe, clean, and polish a desired surface. In the preferred embodiment, the first debris-collecting layer 1 is made of Sherpa material which is a curly piled fabric structure made of synthetic yarns like acrylic or polyester. However, the first debris-collecting layer 1 can also be made of different material such as cotton clothing, microfiber clothing, lather clothing or other similar materials without deviating from the overall objective of the present invention.

In reference to FIGS. 1-4, the second debris-collecting layer 2 is a soft cloth-like surface that is also used to wipe, clean, and polish a desired surface. In the preferred embodiment, the second debris-collecting layer 2 is made of Sherpa material which is a curly piled fabric structure made of synthetic yarns like acrylic or polyester. However, the second debris-collecting layer 2 can also be made of different material such as cotton clothing, microfiber clothing, lather clothing or other similar materials without deviating from the overall objective of the present invention.

Furthermore, the first debris-collecting layer 1 and the second debris-collecting layer 2 of the present invention are preferably a single layer of material that is folded in half and perimetrically connected to each other so that the at least one liquid-absorbing layer 3 can be fully enclosed within. However, the first debris-collecting layer 1 and the second debris-collecting layer 2 of the present invention can also be two separate layers of material that are perimetrically connected to each other to fully enclose the at least one liquid-absorbing layer 3 within. The functionality of the first debris-collecting layer 1 and the second debris-collecting layer 2 are to fully clean the exterior surface of the bowling ball so that the user can complete an accurate shot during the game.

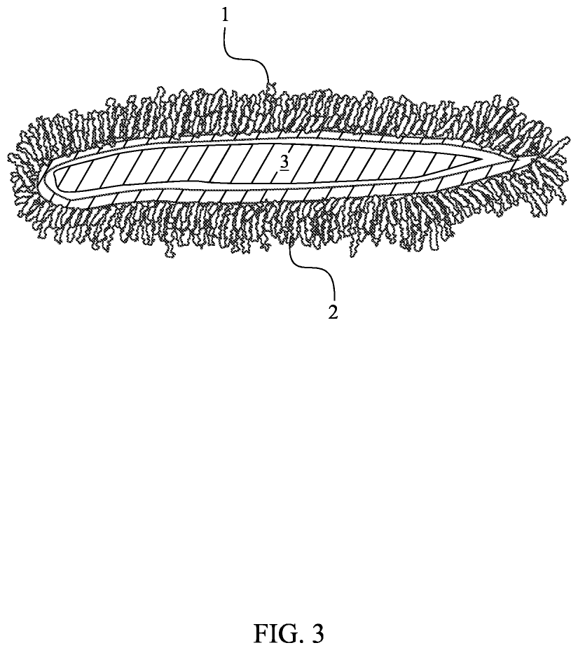

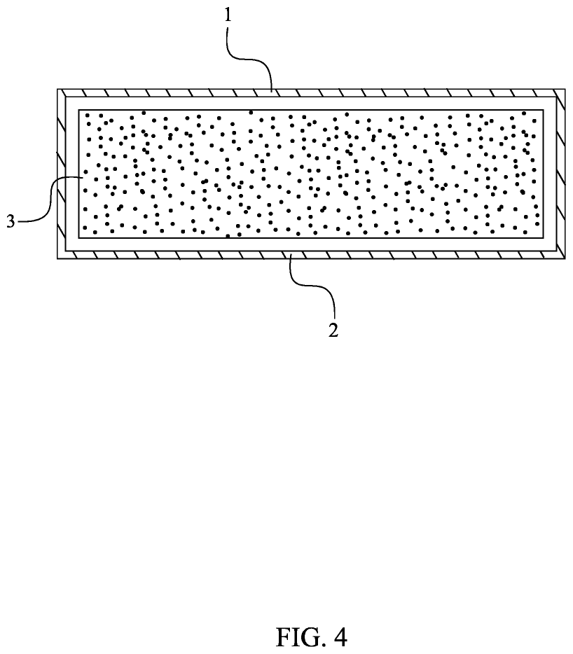

In some embodiment of the present invention, as shown in FIGS. 3 and 4, the at least one liquid-absorbing layer 3 is configured to absorb only water. More specifically, the at least one liquid-absorbing layer 3 attracts and absorb water particles from the first debris-collecting layer 1 and/or the second debris-collecting layer 2 thus resulting a dry surface condition of the first debris-collecting layer 1 and the second debris-collecting layer 2. As a result, the present invention can be continuously used on numerous surfaces or objects until the at least one liquid-absorbing layer 3 exceeds its material properties. For example, the at least one liquid-absorbing layer 3 can be made from natural and synthetic sponge, anhydrous calcium chloride, soda lime, allochroic silica gel, activated carbon, or any other types of water absorbing materials so that the first debris-collecting layer 1 and the second debris-collecting layer 2 are able to fully transfer only water particles to the at least one liquid-absorbing layer 3.

In some embodiment of the present invention, as shown in FIGS. 3 and 4, the at least one liquid-absorbing layer 3 is configured to absorb only oil. More specifically, the at least one liquid-absorbing layer 3 attracts and absorb oil particles from the first debris-collecting layer 1 and/or the second debris-collecting layer 2 thus resulting a dry surface condition of the first debris-collecting layer 1 and the second debris-collecting layer 2. As a result, the present invention can be continuously used on numerous surfaces or objects until the at least one liquid-absorbing layer 3 exceeds its material properties. For example, the at least one liquid-absorbing layer 3 can be made from wicking polypropylene pads, synthetic pads, natural pads such as sawdust or any other types of oil absorbing materials so that the first debris-collecting layer 1 and the second debris-collecting layer 2 are able to fully transfer only oil particles to the at least one liquid-absorbing layer 3.

In some embodiment of the present invention, as shown in FIGS. 3 and 4, the at least one liquid-absorbing layer 3 is configured to absorb water and oil. More specifically, the at least one liquid-absorbing layer 3 attracts and absorb water particles and oil particles from the first debris-collecting layer 1 and/or the second debris-collecting layer 2 thus resulting a dry surface condition of the first debris-collecting layer 1 and the second debris-collecting layer 2. As a result, the present invention can be continuously used on numerous surfaces or objects until the at least one liquid-absorbing layer 3 exceeds its material properties. For example, the at least one liquid-absorbing layer 3 can be made from any combination of wicking polypropylene pads, synthetic pads, natural pads such as sawdust, natural and synthetic sponge, anhydrous calcium chloride, soda lime, allochroic silica gel, activated carbon so that the first debris-collecting layer 1 and the second debris-collecting layer 2 are able to fully transfer water particles and oil particles to the at least one liquid-absorbing layer 3.

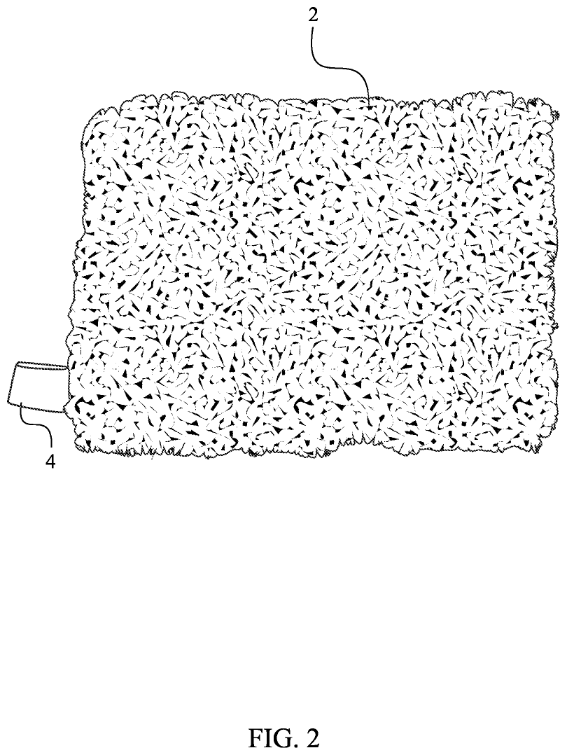

In reference to FIGS. 1 and 2, the present invention further comprises a hanging loop 4. More specifically, the hanging loop 4 body is peripherally connected to the first debris-collecting layer 1 and the second debris-collecting layer 2 and outwardly extended from the first debris-collecting layer 1 and the second debris-collecting layer 2. The hanging loop 4 is an exterior fastening point that allow the user to fasten the present invention to a convenient location by means of a carabiner or of the likes. In other words, the hanging loo is an article that is designed to create a loop to be used as a fastening point for the present invention.

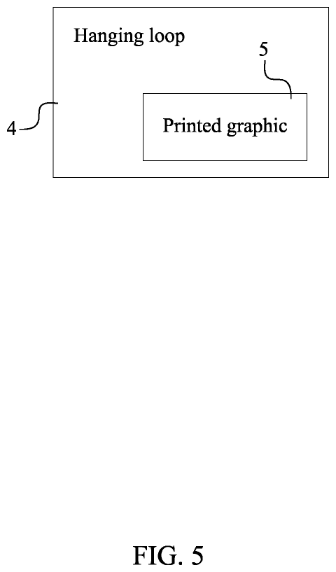

In reference to FIG. 5, the present invention further comprises a printed graphic 5. The printed graphic 5 is inscribed onto the hanging loop 4 and can include, but is not limited to product information, company logo, usage instruction, and marketing information.

To use the present invention, the user has to find an object or surface to be clean and polished. Then, the user needs to grasp the present invention and rub the first debris-collecting layer 1 and/or the second debris-collecting layer 2 on a desired object or surface they intend to clean. Once the present invention is positioned into the palm of the user's hand, the user can simply rub and wipe the first debris-collecting layer 1 and/or the second debris-collecting layer 2 against the desired object or surface. Then, the first debris-collecting layer 1 and/or the second debris-collecting layer 2 wipe and capture water and/or oil from the desired object or surface. The at least one liquid-absorbing layer 3 then draws and contains water and/or oil particles out of the first debris-collecting layer 1 and/or the second debris-collecting layer 2. As a result, the absorption of the water and/or oil by the at least one liquid-absorbing layer 3 is able to keep the first debris-collecting layer 1 and the second debris-collecting layer 2 dry for continuous and multiple use.

Due to the cleaning properties of the present invention, the present invention can clean and polish a bowling ball to assist the user to maintain consistent ball motion when rolled down a bowling lane. Furthermore, the present invention assists with deep cleaning the surface pores of the bowling ball. In addition to cleaning and polishing, the present invention also enhances the longevity of the bowling ball by removing ball tac and belt marks from the surface of the bowling ball.

Although the invention has been explained in relation to its preferred embodiment, it is to be understood that many other possible modifications and variations can be made without departing from the spirit and scope of the invention as hereinafter claimed.

What is claimed is:

1. A bowling-ball cleaning pad comprising:
a first debris-collecting layer;
a second debris-collecting layer;
at least one liquid-absorbing layer;
the at least one liquid-absorbing layer being sandwiched in between the first debris-collecting layer and the second debris-collecting layer;
the first debris-collecting layer, the second debris-collecting layer, and the at least one liquid-absorbing layer being coextensive with each other; and
the first debris-collecting layer and the second debris-collecting layer being perimetrically connected to each other.

2. The bowling-ball cleaning pad as claimed in claim 1, wherein the at least one liquid-absorbing layer is configured to absorb only water.

3. The bowling-ball cleaning pad as claimed in claim 1, wherein the at least one liquid-absorbing layer is configured to absorb only oil.

4. The bowling-ball cleaning pad as claimed in claim 3, wherein the at least one liquid-absorbing layer is a wicking polypropylene pad.

5. The bowling-ball cleaning pad as claimed in claim 1, wherein the at least one liquid-absorbing layer is configured to absorb water and oil.

6. The bowling-ball cleaning pad as claimed in claim 1, wherein the first debris-collecting layer and the second debris-collecting layer are configured to clean a bowling ball.

7. The bowling-ball cleaning pad as claimed in claim 1 comprising:
a hanging loop; and
the hanging loop body being peripherally connected to the first debris-collecting layer and the second debris-collecting layer.

8. The bowling-ball cleaning pad as claimed in claim 7 comprising:
a printed graphic; and
the printed graphic being inscribed onto the hanging loop.

9. A bowling-ball cleaning pad comprising:
a first debris-collecting layer;
a second debris-collecting layer;
at least one liquid-absorbing layer;
a hanging loop;
the at least one liquid-absorbing layer being sandwiched in between the first debris-collecting layer and the second debris-collecting layer;
the first debris-collecting layer, the second debris-collecting layer, and the at least one liquid-absorbing layer being coextensive with each other;
the first debris-collecting layer and the second debris-collecting layer being perimetrically connected to each other; and
the hanging loop body being peripherally connected to the first debris-collecting layer and the second debris-collecting layer.

10. The bowling-ball cleaning pad as claimed in claim 9, wherein the at least one liquid-absorbing layer is configured to absorb only water.

11. The bowling-ball cleaning pad as claimed in claim 9, wherein the at least one liquid-absorbing layer is configured to absorb only oil.

12. The bowling-ball cleaning pad as claimed in claim 11, wherein the at least one liquid-absorbing layer is a wicking polypropylene pad.

13. The bowling-ball cleaning pad as claimed in claim 9, wherein the at least one liquid-absorbing layer is configured to absorb water and oil.

14. The bowling-ball cleaning pad as claimed in claim 9, wherein the first debris-collecting layer and the second debris-collecting layer are configured to clean a bowling ball.

15. The bowling-ball cleaning pad as claimed in claim 9 comprising:
a printed graphic; and
the printed graphic being inscribed onto the hanging loop.

16. A bowling-ball cleaning pad comprising:
a first debris-collecting layer;
a second debris-collecting layer;
at least one liquid-absorbing layer;
a hanging loop;
a printed graphic;
the at least one liquid-absorbing layer being sandwiched in between the first debris-collecting layer and the second debris-collecting layer;
the first debris-collecting layer, the second debris-collecting layer, and the at least one liquid-absorbing layer being coextensive with each other;
the first debris-collecting layer and the second debris-collecting layer being perimetrically connected to each other;
the hanging loop body being peripherally connected to the first debris-collecting layer and the second debris-collecting layer; and
the printed graphic being inscribed onto the hanging loop.

17. The bowling-ball cleaning pad as claimed in claim 16, wherein the at least one liquid-absorbing layer is configured to absorb only water.

18. The bowling-ball cleaning pad as claimed in claim 16 comprising:
wherein the at least one liquid-absorbing layer being configured to absorb only oil; and
wherein the at least one liquid-absorbing layer being a wicking polypropylene pad.

19. The bowling-ball cleaning pad as claimed in claim 16, wherein the at least one liquid-absorbing layer is configured to absorb water and oil.

20. The bowling-ball cleaning pad as claimed in claim 16, wherein the first debris-collecting layer and the second debris-collecting layer are configured to clean a bowling ball.
